(19) United States
(12) Patent Application Publication
(10) Pub. No.: US 2025/0197159 A1
(43) Pub. Date: Jun. 19, 2025

(54) SPOOL TRANSPORTER

(71) Applicant: Albert Ben Currey, Phoenix, AZ (US)

(72) Inventor: Albert Ben Currey, Phoenix, AZ (US)

(21) Appl. No.: 18/539,473

(22) Filed: Dec. 14, 2023

(51) Int. Cl. B65H 49/32

(52) U.S. Cl. CPC B65H 49/324

(57) ABSTRACT

A spool transporter is provided. The spool transporter includes a vehicle comprising a cab and a frame with front and rear wheels operatively coupled to the frame and at least two spool retaining devices coupled to a top surface of the frame. Each spool retaining device is configured to retain a spool/reel wound with and retaining cable and each spool retaining device may be rotatable. The spool transporter includes a loader coupled to the top surface of the frame for loading spools/reels onto the at least two spool retaining devices. The vehicle is configured to perform a crabwalk maneuver and/or U-turn maneuver. each spool retaining device is rotatable. The vehicle may also include leveling component to level the frame when the vehicle is on an incline.

### BACKGROUND OF THE INVENTION

### Technical Field

This invention relates generally to a spool transporter and more particularly to a spool transporter that is a vehicle with a boom for loading cable reels/spools onto the vehicle.

### State of the Art

The use of cable reels and spools is common in various types of construction from renewable energy cable lines to transmission cable lines that are placed in-ground, above ground and so forth. There is difficulty in getting the cable reels to areas that have uneven terrain. Conventionally, reel transport trucks that can be loaded with a single spool are used and then taken to a location needed where the reel may be moved to a payout position to install the cable. Other conventional transportation of cable spools is a trailer that can be loaded, however, they must be loaded with a crane or other device and then transported. The trailers are also cumbersome to move once on site because it requires yet another vehicle to transport over the rough terrain and often times it is not only difficult to move the trailer, but the vehicle has a difficult time also.

Accordingly, there is a need for an improved spool transporter that comprises vehicle and a boom for loading cable reels/spools onto the vehicle and transported to a location for payout from the vehicle.

### SUMMARY OF THE INVENTION

An embodiment includes a spool transporter comprising: a vehicle comprising a cab and a frame with front and rear wheels operatively coupled to the frame; at least two spool retaining devices coupled to a top surface of the frame, wherein each spool retaining device is configured to retain a spool/reel wound with and retaining cable; and a loader coupled to the top surface of the frame for loading spools/reels onto the at least two spool retaining devices.

An embodiment includes a method of operating a spool transporter, the method comprising: operating a loader to load one or more spools/reels from a first location onto a frame of a vehicle of the spool transporter; securing the one or more spools/reels onto the frame with one or more spool retaining devices; transporting the one or more spools/reels from the first location to a second location for payout of the cable wound on the spools/reels; and performing payout of the cable.

Another embodiment includes a spool transporter comprising: a vehicle comprising a cab and a frame with front and rear wheels operatively coupled to the frame; and at least two spool retaining devices coupled to a top surface of the frame, wherein each spool retaining device is configured to retain a spool/reel wound with and retaining cable.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a side view of a spool transport vehicle loaded with spools according to an embodiment;

FIG. 2 is a side view of a spool transport vehicle loaded with spools according to an embodiment;

FIG. 3 is a side view of a spool transport vehicle loading spools according to an embodiment;

FIG. 4 is a side view of a spool transport vehicle loading spools according to an embodiment;

FIG. 5 is a side view of a spool transport vehicle loaded with spools performing a crab walk according to an embodiment; and

FIG. 6 is a side view of a spool transport vehicle loaded with spools performing a U-turn according to an embodiment.

### DETAILED DESCRIPTION OF EMBODIMENTS OF THE INVENTION

As discussed above, embodiments of the present invention relate to a spool transporter that comprises a vehicle and a boom for loading cable reels/spools onto the vehicle and transported to a location for payout from the vehicle.

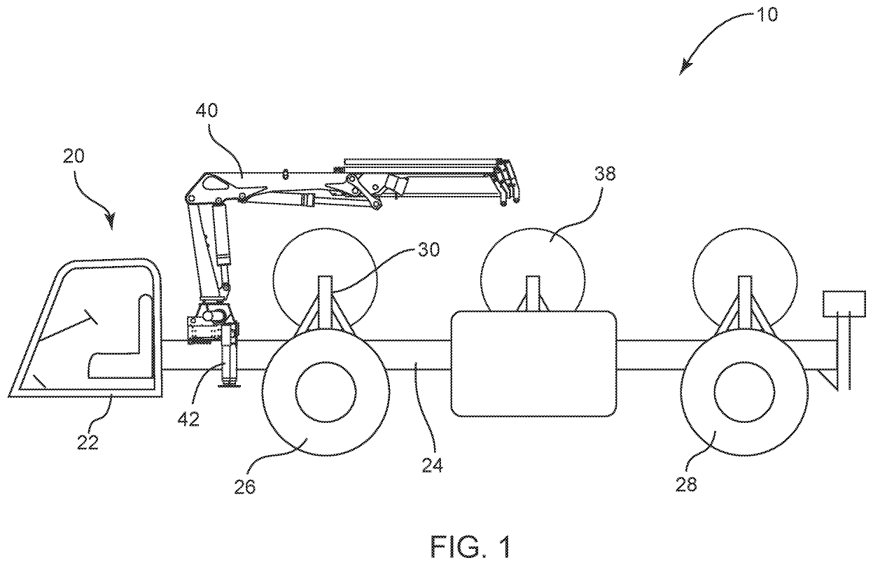

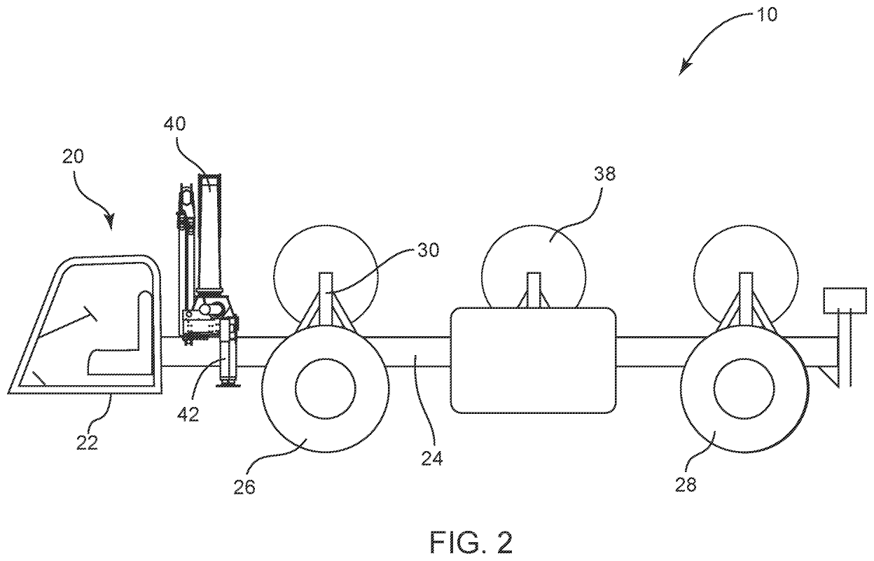

Embodiments of a spool transporter 10 are depicted in FIGS. 1-6. The transporter comprises a vehicle 20 that has a cab 22 and a frame 24 with front and rear wheels 26 and 28 operatively coupled to the frame 24. The frame 24 comprises at least two spool retaining devices 30, each spool retaining device 30 configured to retain a spool/reel 38 wound with and retaining cable or the like. The frame 24 further comprises a loader 40, such as, a knuckle boom or a boom, for loading spools/reels 38 onto the spool retaining devices 30.

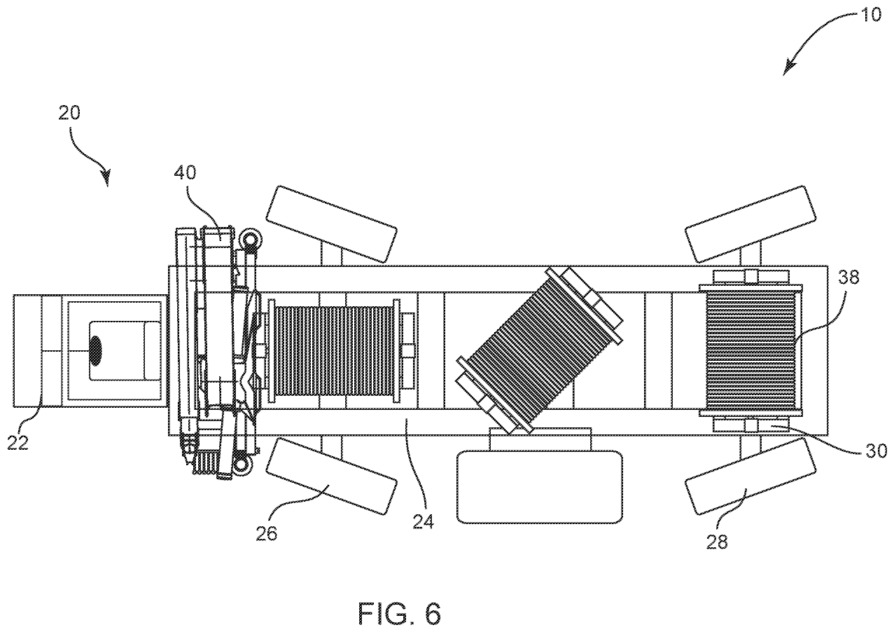

The spool retaining device 30 includes a base 32, a bottom frame 34 and two spool supports 36 that are coupled to and extend perpendicular from the bottom frame 34. The two spool supports 36 are separated a distance sufficient to receive an axle 39 extending through the spool/reel 38 and retain the spool/reel 38 in a condition that allows for payout of cable wound on the spool/reel 38 or to maintain the spool/reel 38 in a fixed position to inhibit payout of the cable. Further, the base 32 operates to couple to the frame 24. In embodiments, the base 32 may be a rotatable base 32 and rotate the bottom frame 34 with respect to the frame 24. The rotatable base 32 may include a locking mechanism that releasably locks the bottom frame in various rotated positions, such as that shown in FIG. 6. In these locked positions, the spools/reels 38 may be oriented in a desired position for payout. Embodiments of the spool transporter 10 thereby operate to move the spools/reels 38 over rough and uneven terrain and then to operate as a payout device for the spools/reels 38 coupled thereto.

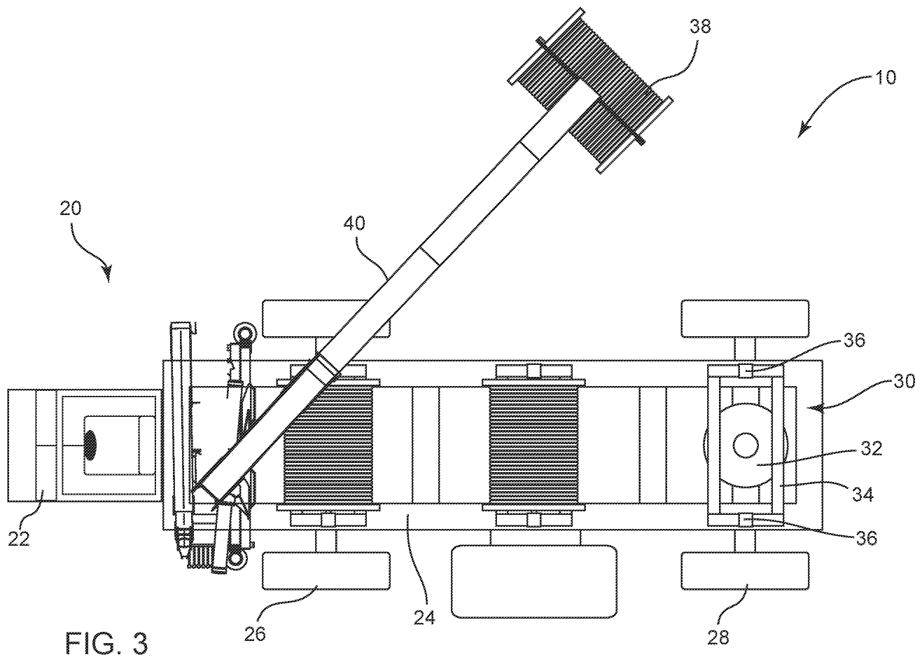

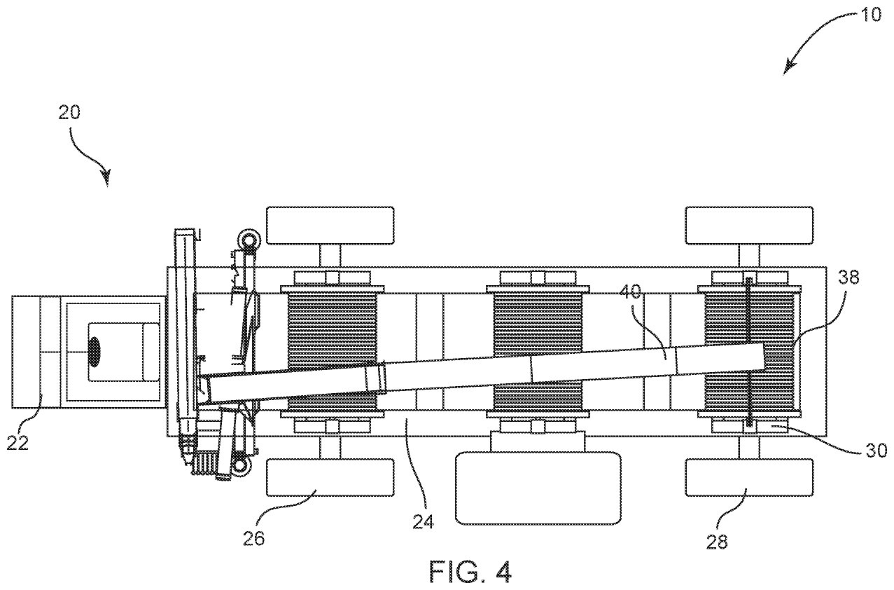

The loader 40 may operate to load spools/reels 38 onto the frame 24 of the vehicle 20. The loader 40 may comprise a knuckle boom, as shown in the drawing figures, or a boom (not shown). The loader 40 may include stabilizing legs 42 that operate to ensure the loader 40 is stable when loading a spool/reel 38, particularly when extended, as shown in FIGS. 3-4. The loader 40 may utilize cables or other means of coupling to a spool/reel 38 and pick up from a first location, such as on a transport truck or on a ground surface and move it into position adjacent a spool retaining device 30. The spool/reel 38 may then be coupled onto the spool retaining device 30.

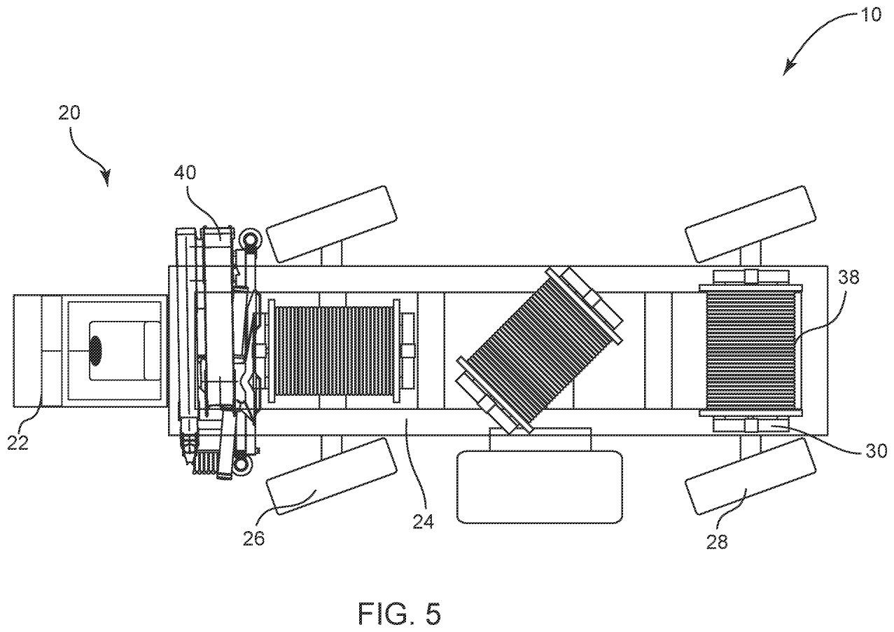

Once the spool transporter 10 is loaded, it may move the spools/reels 38 loaded on the frame 24 of the vehicle 20 to a desired location. To assist in the traversal of rough, even terrain, the vehicle 20 may have various steering capabilities. In some embodiments, as shown in FIG. 5, the vehicle 20 may perform a crabwalk maneuver, wherein the crabwalk maneuver includes the front wheel 26 and the rear wheel 28 turning in a same direction. This allows the front and the back of the vehicle to move simultaneously in a same direction, thereby allowing for easier positioning of the spool transporter 10 to place the reels/spools 38 in a location for payout. Furthermore, in some embodiments, as shown in FIG. 6, the vehicle 20 may perform a U-turn maneuver, wherein the U-turn maneuver includes the front wheel 26 and the rear wheel 28 turning in opposite directions. This allows for a tighter U-turn maneuver by moving both the front and the rear of the vehicle 20, thereby allowing for easier positioning of the spool transporter 10 to place the reels/spools 38 in a location for payout.

Further, the vehicle 20 may include leveling components (not shown), such as hydraulics. The leveling components may operate to level the frame 24 when the vehicle 20 is on a slope or incline. This allows the reels/spools 38 to always be in a level position during payout and avoids tangling or other issues that can arise when the reels/spools 38 are generally horizontal.

A method of operating a spool transporter 10 includes operating a loader to load one or more spools/reels from a first location onto a frame of a vehicle of the spool transporter; securing the one or more spools/reels onto the frame with one or more spool retaining devices; transporting the one or more spools/reels from the first location to a second location for payout of the cable wound on the spools/reels; and payout the cable.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A spool transporter comprising:
a vehicle comprising a cab and a frame with front and rear wheels operatively coupled to the frame;
at least two spool retaining devices coupled to a top surface of the frame, wherein each spool retaining device is configured to retain a spool/reel wound with and retaining cable; and
a loader coupled to the top surface of the frame for loading spools/reels onto the at least two spool retaining devices.

2. The spool transporter of claim 1, wherein the loader comprises a knuckle boom or a boom.

3. The spool transporter of claim 2, wherein the loader comprises stabilizing legs that operate maintain the loader stable when loading spools/reels.

4. The spool transporter of claim 3, wherein each spool retaining device comprises:
a base coupled to the top surface of the frame of the vehicle;
a bottom frame coupled to the rotatable base; and
two spool supports coupled to and extending perpendicular from the bottom frame, wherein the two spool supports are separated a distance sufficient to receive an axle extending through the spool/reel.

5. The spool transport of claim 4, wherein each spool retaining device retains the spool/reel in a condition that allows for payout of cable wound on the spool/reel.

6. The spool transport of claim 5, wherein each spool retaining device retains the spool/reel in a fixed position to inhibit payout of the cable.

7. The spool transport of claim 6, wherein the base is a rotatable base to make each spool retaining device rotatable.

8. The spool transport of claim 6, further comprising leveling components to level the frame when the vehicle is on an incline.

9. The spool transport of claim of claim 6, wherein the front and rear wheels are configured to perform a crabwalk maneuver.

10. The spool transport of claim of claim 9, wherein the front and rear wheels are configured to perform a U-turn maneuver.

11. A method of operating a spool transporter, the method comprising:
operating a loader to load one or more spools/reels from a first location onto a frame of a vehicle of the spool transporter;
securing the one or more spools/reels onto the frame with one or more spool retaining devices;
transporting the one or more spools/reels from the first location to a second location for payout of the cable wound on the spools/reels; and
performing payout of the cable.

12. The method of claim 11, wherein the loader comprises a knuckle boom or a boom.

13. The method of claim 12, wherein the loader comprises stabilizing legs that operate maintain the loader stable when loading spools/reels.

14. The method of claim 13, wherein each spool retaining device comprises:
a rotatable base coupled to the top surface of the frame of the vehicle;
a bottom frame coupled to the rotatable base; and
two spool supports coupled to and extending perpendicular from the bottom frame, wherein the two spool supports are separated a distance sufficient to receive an axle extending through the spool/reel.

15. The method of claim 14, wherein transporting the one or more spools/reels from the first location to a second location for payout of the cable wound on the spools/reels comprises performing a crabwalk maneuver.

16. The method of claim 14, wherein transporting the one or more spools/reels from the first location to a second location for payout of the cable wound on the spools/reels comprises performing a U-turn maneuver.

17. A spool transporter comprising:
a vehicle comprising a cab and a frame with front and rear wheels operatively coupled to the frame; and
at least two spool retaining devices coupled to a top surface of the frame, wherein each spool retaining device is configured to retain a spool/reel wound with and retaining cable.

18. The spool transporter of claim 3, wherein each spool retaining device comprises:
a base coupled to the top surface of the frame of the vehicle;
a bottom frame coupled to the rotatable base; and
two spool supports coupled to and extending perpendicular from the bottom frame, wherein the two spool supports are separated a distance sufficient to receive an axle extending through the spool/reel.

19. The spool transport of claim 18, wherein the base is a rotatable base to make each spool retaining device rotatable.

20. The spool transport of claim of claim 19, wherein the front and rear wheels are configured to perform a crabwalk maneuver and to perform a U-turn maneuver.
